(19) United States
(12) Patent Application Publication
(10) Pub. No.: US 2006/0148417 A1
(43) Pub. Date: Jul. 6, 2006

(54) Telecommunications terminal and telecommunications assembly

(76) Inventor: Jurgen Luers, Borchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/562,348

(22) PCT Filed: Jun. 7, 2004
(86) PCT No.: PCT/EP04/51041

§ 371 Date: Dec. 27, 2005

(30) Foreign Application Priority Data
Jul. 3, 2003 (DE) 103 30 075.9

(51) Int. Cl. H04B 1/38

(52) U.S. Cl. 455/73; 455/41.2

(57) ABSTRACT

A telecommunications terminal comprising a user interface function for a plurality of telecommunications connections, in addition to selection means for inputting telecommunications connection data, call signaling means for signaling incoming calls to one of the telecommunications connections, input means for inputting outgoing messages, output means for outputting incoming messages and a local-area radio transceiver for wireless message traffic permitting the transmission of the telecommunications connection data and outgoing messages to at least one external gateway and the receipt of call signals and incoming messages from the external gateway for establishing one of the telecommunications connections, or preferably to or from several external gateways for establishing several telecommunications connections is provided.

### CROSS REFERENCE TO RELATED APPLICATIONS

This application is the US National Stage of International Application No. PCT/EP2004/051041, filed Jun. 7, 2004 and claims the benefit thereof. The International Application claims the benefits of German application No. 10330075.9 DE filed Jul. 3, 2003, both of the applications are incorporated by reference herein in their entirety.

### FIELD OF INVENTION

The invention relates to a special telecommunications terminal comprising a novel functionality, said telecommunications terminal being referred to hereinbelow as a “communications agent” or else “agent” for short, and to a telecommunications assembly comprising at least one telecommunications terminal of this type.

### BACKGROUND OF INVENTION

Telecommunications and data communications nowadays determine to a very large extent processes in the economy and social life of the industrialized countries, and, for many people there, also processes in their private lives.

The use of multiple communications terminals is widespread. Many have a telephone at home connected to a fixed network, and when traveling often a private mobile phone. The workplace is usually equipped with a telephone which is connected to the company's internal telephone network. Sometimes the company's internal telephone network can in addition also be used on the company site via a mobile phone. And many cars are fitted with mobile phones.

This gives rise to a range of problems for the user:
he/she has to familiarize himself/herself with the operation of all the terminals. When switching between equipment, he/she has to reorient himself/herself.
Incoming calls and/or messages are predominantly signaled to the terminal location. If the user is not in the immediate vicinity, he may fail to hear the signaling tone.
In the case of incoming calls and/or messages, the user has to proceed to the respective terminal under time pressure.
If a mobile terminal is used jointly by multiple users, the user may optionally have to search for the terminal (in the case of incoming calls under time pressure).
If the user maintains an address book via a terminal, then he/she cannot readily use the communication addresses stored therein also on other terminals. In the worst-case scenario, he/she cannot establish a connection since the data necessary for doing so is not available on the terminal then being used. Furthermore, he/she has to match the data reciprocally and usually keep multiple records. This also applies to all other personal data such as that found e.g. in an appointments calendar.
If a connection was established via a fixed terminal, the connection has to be terminated in emergencies (e.g. food is burning).
If the terminal is used by multiple users, the respective user cannot be identified. For secure identification a separate logon with password input has to be implemented on each terminal. And passwords are always problematic.
The user has no systematic overview of the communication means available at the location and consequently cannot also readily select the most cost-effective form of communication.

These problems, which are by no means limited to voice connections but apply analogously also to image, video and data transmissions, are for the majority of the population in the industrialized countries a daily trial. They hamper the handling of modem communications technology in a very significant way. As well as time wastage of an economically relevant magnitude, they also lead on a massive scale to errors or failures when attempting to establish contact with others via telecommunications connections.

### SUMMARY OF INVENTION

An object of the invention is therefore to provide an improved telecommunications terminal and a corresponding telecommunications assembly which can considerably simplify the handling of the various telecommunications connections of typical users that are available with regard to the above-mentioned problems, save time and to a large extent eliminate sources of errors.

This object is achieved in a telecommunications terminal and a telecommunications assembly having of the features the independent claims. Useful further developments of the inventive idea are the subject matter of the dependent claims.

The invention includes the following essential ideas:

The user carries with him/her a novel communications terminal which is referred to below as a communications agent or in short as an agent. This agent is restricted to his person and establishes via a local-area radio technology yet to be defined and standardized contact with gateways present locally. Each gateway provides access to a communications network and does not necessarily have to have a user interface. The gateway functionality can, however, also be integrated in existing forms of terminals (even in the “agent” itself), so that agents can establish contact directly via the underlying local-area radio network (i.e. circumventing any other infrastructure which may be subject to charges).

According to a first useful embodiment, the telecommunications terminal has precisely one internal gateway for connecting to a mobile radiocommunications network, to which gateway the selection means, call signaling means, input means and output means are connected via internal lines such that the telecommunications terminal is configured as a complete mobile radiocommunications terminal. In this sense, the mobile phone already being carried on their person by the majority of all mobile phone users becomes a telecommunications terminal of the type according to the invention or communications agent, but retains its full functionality as a mobile phone.

In another useful further development, the communications agent (the novel terminal) has a local-area radio transceiver according to the Bluetooth standard, comprising loadware adapted for connecting to the, or to each, gateway. The Bluetooth standard, which has for a number of years been establishing itself increasingly for linking different types of small electronic devices, thus finds a novel application here.

In another variant, the communications agent has a radio transceiver of the wireless LAN type, comprising loadware adapted for connecting to the, or each, gateway. The essential technical prerequisites have also been established for this in recent years in that advanced wireless-LAN solutions of varying complexity have been developed and trialed in practice.

Of particular advantage to users is a configuration in which the terminal or the agent includes an address-book memory assigned to the selection means, for storing connection-data records of a plurality of predetermined connections which can be established with the external gateway or external gateways and optionally an internal gateway. Similarly useful is a further upgrade to a PDA functionality, like that already found today in high-quality mobile radiocommunication terminals.

In addition, the comparison can be made here with a purse which in this case can also store and safeguard data material relating to digital signature or other keywords, as certain smartcards are nowadays already doing. To express it in more general terms, such an agent can thus also transport and safeguard other user-specific data besides address data. It would thus also be conceivable for the agent to transport account numbers and bank sort codes or credit card numbers.

In order on the one hand to ensure that unauthorized agents do not use the gateways, and in order on the other hand to keep the demand for free channels on the local-area radio equipment used low, the gateways should only communicate with agents which have been cleared for them. As a spin-off, the agents should thus also display only the gateways which are really important for the user.

To this end, the proposed terminal comprises in a preferred embodiment authentication-data input means for inputting authentication data of a user, which means are connected to the local-area radio transceiver for transmitting the authentication data to the, or to each, external gateway.

From the point of view of the system, the function of the proposed telecommunications assembly will take approximately the following form:

As soon as the agent enters the vicinity of a suitable gateway, it detects its presence from the strength of the incident signal and commences an automatic logon sequence that has yet to be defined and standardized. In doing so, it makes known its identity and consequently also that of the assigned user to the gateway. The gateway checks what privileges the respective agent (or the user associated with it or an associated user group) possesses and then communicates to it its own identification and the forms of communication that can be used. Acknowledgement of these by the agent completes the logon procedure.

For example, a publicly accessible gateway at a central location or as a replacement for/addition to the public telephone kiosk would, however, also be conceivable. In this case, the user would not yet be known to the gateway. In the course of the logon procedure, a user ID and a separate password (possibly supplemented by an account number and a bank sort code) would therefore also have to be transmitted securely to the gateway, in order that the costs could then be debited from the account, for example, or in order that the credit card could be charged with the amount. The agent would optionally display such a public gateway in a particular form if no incoming calls are being signaled via it. It would also be conceivable for costs or other preliminary information pertaining to the gateway to be displayed.

The agent visualizes the identifications of the locally available gateways and the possible forms of communication associated with them and supported by it. It also provides a suitable user interface for each of these forms of communication. The agent thus functions as a universal terminal via which all visualized gateways and forms of communication can be used.

Depending on the specific hardware configurations and the assigned privileges and settings, incoming calls are signaled either exclusively or in parallel on the agent and can be received by the user directly via said agent. The facility should also exist for initiating outgoing calls, connections and messages and handling them fully from the agent. The data transported between agent and gateway should preferably be exchanged via the same local-area radio network via which the automatic logon procedure has already run.

This method offers the following advantages:
The user is constantly informed about locally available gateways and forms of communication and can use them without having to refamiliarize himself/herself.
The user is constantly accessible via locally available gateways.
Besides the non-recurrent cost of configuring the agent and the gateways no further cost generally accrues to the user, in particular when changing location.
The user can always carry with him/her his/her personal data inventory such as e.g. address list, appointments calendar, e-mail and data files.
The signaling of incoming calls and messages is carried out centrally from the user's viewpoint.
Security is increased as the user has to protect only a single device (namely the agent assigned to him and carried by him) and also has to store only a single authentication code.
If messages have in the meantime been received at a gateway, then it can selectively inform the user of this as soon as said user comes into range with his agent.
The user can be constantly informed about the most cost-effective form of communication available locally.

In terms of user authorization, the, or each, telecommunications terminal in the system has authentication-data input means for inputting authentication data of a user, which means are connected to the local-area radio transceiver for transmitting the authentication data externally. The, or each, external gateway connectable hereto has local-area radio receiving means configured for receiving the authentication data and access control means connected hereto for releasing or blocking message traffic with the sending telecommunications terminal in response to the result of a check of the authentication data received.

In terms of dynamic gateway access, the local-area radio receiver of the, or of each, external gateway in the system has a threshold discriminator for recording the entry into the radio transmission range of the, or of a, telecommunications terminal. Connected to the output of the threshold discriminator is a communications-start controller for initiating a communications-start procedure with the telecommunications terminal concerned such that upon entry into radio transmission range, optionally subject to a positive authentication check, message traffic is established between the telecommunications terminal and the gateway.

In a further preferred configuration, the system includes a plurality of telecommunications terminals, the local-area transceivers of which are configured for exchanging messages with one another without the intermediate connection of an external network. To this end, a group of the novel telecommunications terminals (agents) can, for example within a family, take over the function of a wireless internal communications system, operation of which does not give rise to any costs for using an external network.

In order to implement the gateway functionality for fixed-network connections and fixed-installation mobile telephones in motor vehicles, two approaches can be considered. On the one hand, new versions of conventional terminals could be upgraded with a Bluetooth interface comprising the necessary loadware. On the other hand, completely new terminals could be developed having no other functions besides the gateway functionality.

Possible lines for developing other system configurations present themselves similarly, yielding meaningful prospects both for add-on-component product lines for “upgrading” conventional telecommunications terminals for communicating with one or more agents and for fixed-network or mobile radiocommunications gateways for private use which do not have complete terminal functionality and are intended exclusively for communicating in an agent system of the type described here. It will be understood that such gateways can therefore be substantially lower in cost than classic telecommunications terminals, which can generate considerable cost savings, especially in corporate telephone networks.

In other respects, attention must again be drawn in this context once again to the aspect touched upon hereinabove of supplementing the function of public telephone kiosks with a gateway function for interacting with private communications agents.

### BRIEF DESCRIPTION OF THE DRAWINGS

Advantages and useful features of the invention will in other respects emerge from the description hereinbelow of a preferred embodiment and of special aspects of the invention with reference to the attached Figures, in which:

FIG. 1 shows a sketch-type system representation of a communications assembly according to the invention and

FIG. 2 shows a simplified schematic representation (diagrammatic sketch) of a telecommunications terminal serving as a communications agent and of an external gateway communicating with said telecommunications terminal via a local-area radio connection.

### DETAILED DESCRIPTION OF INVENTION

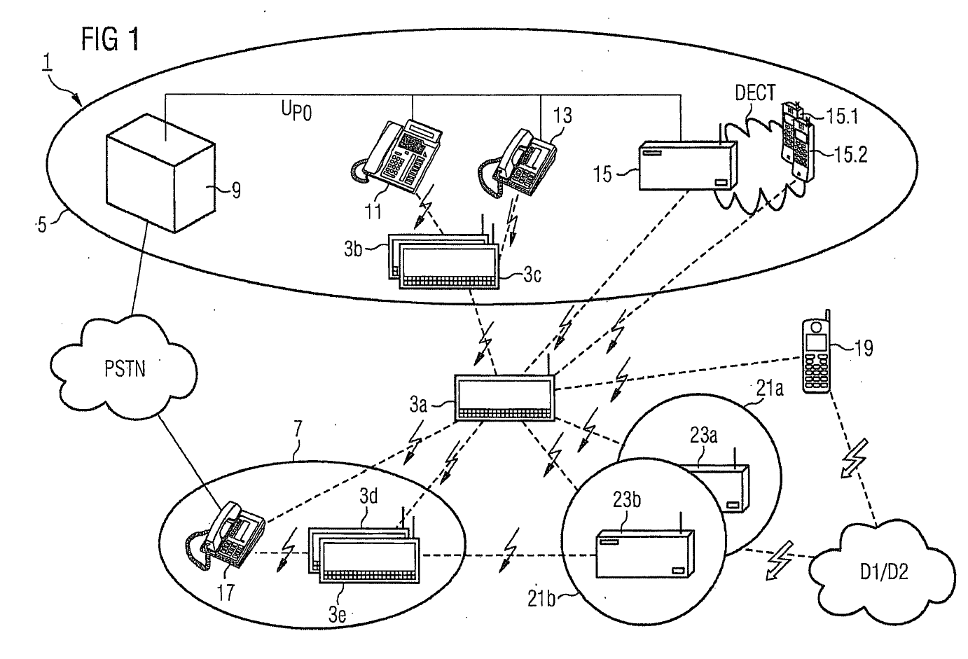

FIG. 1 shows a telecommunications assembly 1 comprising multiple communications agents 3a to 3e, of which the agent 3a belongs to a user whose professional and private communications environment is formed by the telecommunications assembly 1. The telecommunications agents 3b, 3c are assigned to colleagues of this user in a company 5, and the agents 3d, 3e are used by family members in an apartment 7.

In the company 5 there is a telecommunications installation 9 to which a series of terminals used as gateways are connected, of which a first and a second fixed-network telephone 11, 13 and a DECT cordless telephone 15 comprising two handsets 15.1 and 15.2 are shown in the Figure by way of example. In the apartment 7 of the user there is a conventional fixed-network telephone 17 which, like the telecommunications installation 9 in the company 5, is connected to a public fixed network PSTN. The user also uses a mobile telephone 19 and two mobile radio transceiver units 23a, 23b (car gateways), each permanently installed in a car 21a, 21b (company car and wife's private car), which, like the mobile telephone 19, are connected to a mobile radiocommunications network D1, D2 . . .

With all the devices mentioned, some of which are configured as complete terminals and some of which serve with reduced functionality as gateways in the system in accordance with the exemplary embodiment, the user himself who is the focus of attention here and to a certain extent also his/her colleagues and family members communicate via local-area radio connections, which are represented in the Figure by simple lightning bolt symbols (in contrast to the lightning bolts in bold print for mobile radio network connections).

A typical sequence in the use of this system by the user assumed here (father of the family) is approximately as follows: he is at home in the attic and sees on the display of his agent 3a that he can accept calls and conduct outgoing calls via the analog fixed-network PSTN and via the gateway 23a of his company car 21a which is standing in front of the house. He sees that both his wife's car and her agent are not displayed, that she has therefore left the house in her car. He presses the symbol for his older son's agent, who then answers and informs him that his assumption is correct and asks him down for breakfast.

Later, he drives to work. As he comes to a halt in front of the company office, his agent 3a displays again the gateway 23a of his company car and of his workplace telephone 11. He is just on the way to a meeting when he is called via the company car telephone. He notifies the caller that he is already at the office and will be reaching the meeting room immediately. The caller informs him that he should first call by at the server room as a computer has failed. After he has got the server up and running again, he calls using his agent via a colleague's company's internal telephone network and informs the latter about the new situation.

We could cite as a further concrete example family members meeting up in town who could recognize their proximity to one another by the appearance on their own display of the respective other agent. Meeting up in vague and/or crowded areas would be simplified in this way.

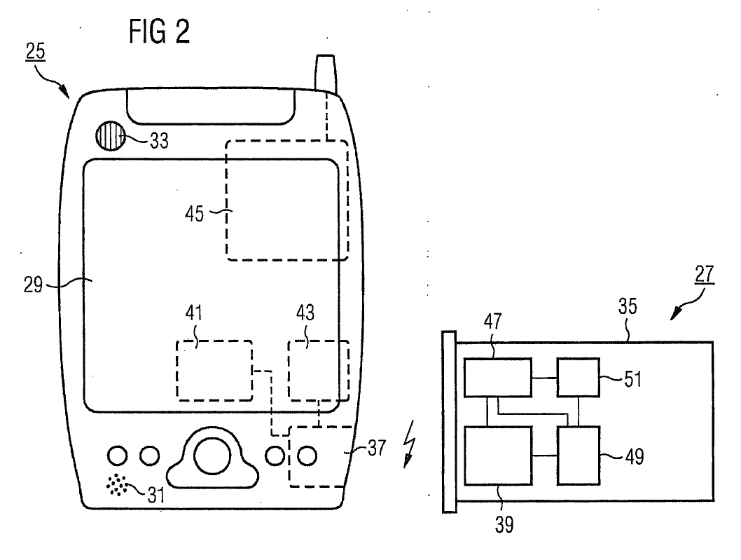

FIG. 2 shows a mobile telephone/PDA combination 25 functioning as a communications agent within the meaning of the invention together with its functions that are most important for the present invention and an assigned fixed-network gateway 27. The mobile telephone/PDA combination 25 has in the usual manner a touchscreen 29 for inputting numerals and text which serves simultaneously as a selection device of the mobile telephone unit, a microphone inset 31 for voice input, a receiver inset 33 for voice output and call signaling (whereby the latter will take place in parallel via the touchscreen 29) and the touchscreen as a means for displaying incoming text, image or video messages.

The fixed-network gateway 27 is essentially formed by an ISDN card, and the connection between mobile telephone/PDA combination 25 and gateway 27 is established by a (known in the art) Bluetooth transceiver 37, 39 in each of the two components. Shown as further essential components in the communications agent 25 are an address-book memory 41 and a first authentication-checking device 43, that is in communication with the touchscreen 29 as an authentication-data input device, and an (internal) mobile radiocommunications gateway 45.

The fixed-network gateway has a second authentication-checking device 47 (access control device) for checking the authorization of access by the communications agent 25 upon entry into the local-area radio range. Finally, the fixed-network gateway 27 also has a threshold discriminator 49 connected to its Bluetooth transceiver 39 for detecting a threshold field strength of the local-area radio link and a communications start controller 51 connected hereto for initiating a logon procedure with the communications agent 25.

The functional relationships described further above are implemented by means of the components shown here, so a repetition of the description in this regard is not required at this point.

Configuration of the invention is not restricted to the examples described above but is equally possible in a plurality of modifications which lie within the scope of expert action.

1.-12. (canceled)

13. A telecommunications terminal having a user interaction function adapted to establish a telecommunications connection, comprising:
a signaling mechanism adapted for signaling incoming calls to the selected connection;
an input device adapted for inputting outgoing messages and a telecommunications connections data;
a display device adapted for displaying incoming messages;
a local-area transceiver adapted for wireless traffic between the telecommunications terminal and an external gateway for establishing the telecommunications connection; and
an internal gateway for connecting to a mobile radio communications network and for interfacing to the selection mechanism, the signaling mechanism, the input device, and the output device, wherein the telecommunications terminal is configured as a mobile-radio-communications terminal.

14. The telecommunications terminal according to claim 13, wherein the local-area transceiver is adapted according to a Bluetooth standard having loadware adapted for connecting to the gateway.

15. The telecommunications terminal according to claim 13, wherein the local-area transceiver is adapted according to a wireless LAN having loadware adapted for connecting to the gateway.

16. The telecommunications terminal according to claim 13, further comprising a user-data memory adapted for storing connection-data records of a predetermined connection that can be established between the external gateway and the telecommunications terminal.

17. The telecommunications terminal according to claim 16, further comprising an authentication-data input for inputting an authentication data of a user, the data authentication-data interfacing with the local-area transceiver for transmitting the authentication data to the gateway.

18. The telecommunications terminal according to claim 17, further comprising a processor and memory to provide PDA functionality that is independent of the telecommunications functions.

19. A telecommunications assembly, comprising:
a telecommunications terminal having a user interaction function adapted to establish a telecommunications connection, comprising:
a signaling mechanism adapted for signaling incoming calls to the selected connection;
an input device adapted for inputting outgoing messages and a telecommunications connections data;
a display device adapted for displaying incoming messages;
a local-area transceiver adapted for wireless traffic between the telecommunications terminal and an external gateway or another telecommunications terminal, including traffic for establishing the telecommunications connection;
an authentication-data input mechanism allowing an authentication-data input, the authentication-data input mechanism interfacing with the local-area transceiver for transmitting the authentication data; and
an external gateway, comprising:
a local-area receiver adapted to receive transmission from telecommunications terminal including the authentication-data input; and
an access control mechanism adapted to block traffic to an unauthorized telecommunications terminal based on the authentication-data input and to release traffic to an authorized telecommunications terminal based on the authentication-data input.

20. The telecommunications assembly according to claim 19, wherein the external gateway excludes a signaling mechanism, an input device, and a display device.

21. The telecommunications assembly according to claim 19, wherein the local-area transceiver includes a threshold discriminator for detecting an entry into the radio transmission range of an telecommunications terminal, the threshold discriminator is operatively connected to a communications-start control device for initiating a communications start procedure with the telecommunications terminal after entering into the radio transmission range.

22. The telecommunications assembly according to claim 21, wherein the telecommunication terminals includes an internal gateway for connecting to a mobile radio communications network and for interfacing to the selection mechanism, the signaling mechanism, the input device, and the output device, wherein the telecommunications terminal is configured as a mobile-radio-communications terminal.

23. The telecommunications assembly according to claim 19, wherein each local-area transceiver for a plurality of the telecommunication terminals are configured for directly exchanging traffic with each other without the intermediate connection of an external network.
